(19) United States
(12) Patent Application Publication
(10) Pub. No.: US 2009/0103039 A1
(43) Pub. Date: Apr. 23, 2009

(54) LIQUID CRYSTAL DISPLAY DEVICE AND MANUFACTURING METHOD OF THE SAME

(76) Inventor: Hitoshi SATOH, Suzuka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/236,147

(22) Filed: Sep. 23, 2008

Related U.S. Application Data
(63) Continuation of application No. PCT/JP2007/053208, filed on Feb. 21, 2007.

(30) Foreign Application Priority Data
Mar. 27, 2006 (JP) 2006-086610

(51) Int. Cl. G02F 1/1339

(52) U.S. Cl. 349/155; 349/187

(57) ABSTRACT

A plurality of beads that will be assigned to either spacer beads 35 or core beads 34 are applied with ink to areas including positioning concavities 32. Then, as the ink vaporizes and the drops get smaller, the plurality of beads move on a surface of the distribution areas 31 while coming closer to each other, and either ones of the beads are held in the positioning concavities 32 and are assigned to the core beads 34. Since the core beads 34 cannot move out of the positioning concavities 32 (to the surface of the distribution areas 31), the other beads which remain on the distributions areas 31 are drawn to the core beads 31, come adjacent to the core beads 34 on the distribution areas 31, and are assigned to the spacer beads 35.

This application is a continuation of PCT/JP2007/053208, filed Feb. 21, 2007, which in turn claims the benefit of Japanese Patent application JP2006-086610, filed Mar. 27, 2006, the priority of both of which are hereby claimed and both incorporated by reference herein in their entirety.

### TECHNICAL FIELD

The present invention relates to a liquid crystal display device and a manufacturing method of the same. More specifically, the present invention relates to a liquid crystal display device that maintains a space between transparent substrates with spacer beads, and a manufacturing method of the liquid crystal display device.

### BACKGROUND

A liquid crystal display device comprises a transparent substrate that is made of glass and has a TFT (thin film transistor) formed thereon, a transparent substrate that made of glass and having RGB distributed thereon and thereby configuring color filters, and liquid crystal that is held between the substrates. In order to prevent display unevenness and the like, it is required for such a liquid crystal panel that a liquid crystal layer, or a cell gap, be uniform in thickness. Devices to make the uniform cell gap have been manufactured, one example of which is a device having spherical spacer beads as disclosed in Japanese Unexamined Patent Application Publication No. 2005-10412, in which the spacer beads are disposed between the transparent substrates and thus arranged to maintain a uniform distance between the transparent substrates over the whole surfaces of the substrates.

However, if the spherical spacer beads enter a display area of the liquid crystal display device, they can cause disarray in alignment of liquid crystal molecules in the display area, which results in troubling lower display quality. It is therefore expected that the spacer beads be allocated if possible within a light shield area that is not involved in image display. However, it is difficult to allocate the spherical spacer beads at preferred places such as the light shield area.

### SUMMARY

A liquid crystal display device in accordance with an example embodiment comprises a pair of transparent substrates, a spacer bead that holds the pair of transparent substrates at a predetermined distance, and liquid crystal that is sealed between the pair of transparent substrates. A distribution area is provided on a light shield area on at least one of the pair of transparent substrates, the distribution area being an area where the spacer bead is disposed. A positioning cavity (also known as “concavity”) is formed in the distribution area, the positioning cavity being concaved or having a concave shape relative to a surface of the distribution area. A core bead is held in the positioning concavity in a state being restricted in movement to the surface of the distribution area. The spacer bead is disposed in a form adjacent to the core bead on the surface of the distribution area.

In addition, a method of manufacturing a liquid crystal display device in accordance with an example embodiment includes: forming a positioning cavity in a distribution area that is set in a light shield area on one of a pair of transparent substrates, the positioning cavity being concaved or having a concave shape relative to a surface of the distribution area; applying a plurality of beads with ink to an area including the positioning cavity on the one of the transparent substrates; as the ink vaporizes, holding one of the plurality of beads in the positioning cavity whereby the one of the plurality of beads becomes a core bead, while drawing the beads which remain on the surface of the distribution area to the core bead and thereby becoming spacer beads; assembling the pair of transparent substrates with the spacer beads held therebetween and thereby spacing a predetermined distance therebetween; and dispensing or sealing liquid crystal in a space between the assembled pair of transparent substrates.

In accordance with an example embodiment, the plurality of beads that become or are to be assigned as the spacer beads or the core bead are applied with ink to an area including the positioning cavity with an inkjet apparatus or the like. Then, as the ink vaporizes and the drop gets smaller, the plurality of beads move on the distribution area while coming closer to each other, and one of the beads is held in the positioning concavity to become the core bead. The core bead in the positioning concavity cannot move out of the positioning concavity (to a surface of the distribution area). Therefore, as the ink drop gets smaller, the other beads which remain in the distribution area are drawn to the core bead in accordance with the vaporization of the ink, are disposed on the surface of the distribution area with being adjacent to the core bead, and thus become the spacer beads. As described, in accordance with an example embodiment, the spacer bead is disposed with being adjacent to the core bead that is restricted in movement. The spacer beads are thus prevented from being positioned outside of the desired distribution area.

### BRIEF DESCRIPTION OF THE DRAWINGS

FIG. 1 is an enlarged plan view of a TFT substrate (a transparent substrate) of a first embodiment;

FIG. 2 is a sectional view taken along line X-X of FIG. 1;

FIG. 3 is an enlarged partial view of a distribution area of FIG. 2;

FIG. 4 is a perspective view of the distribution area;

FIG. 5 is an enlarged partial view of a second embodiment; and

FIG. 6 is an enlarged plan view of a TFT substrate (a transparent substrate) of a third embodiment.

### EXPLANATION OF NUMERALS

10 . . . TFT substrate (a transparent substrate)
14 . . . a driving element
20 . . . a CF substrate (a transparent substrate)
23 . . . a light shield black layer
30 . . . a light shield area
31 . . . a distribution area
32 . . . a positioning concavity
34 . . . a core bead
35 . . . a spacer bead
36 . . . liquid crystal

### DETAILED DESCRIPTION

### First Embodiment

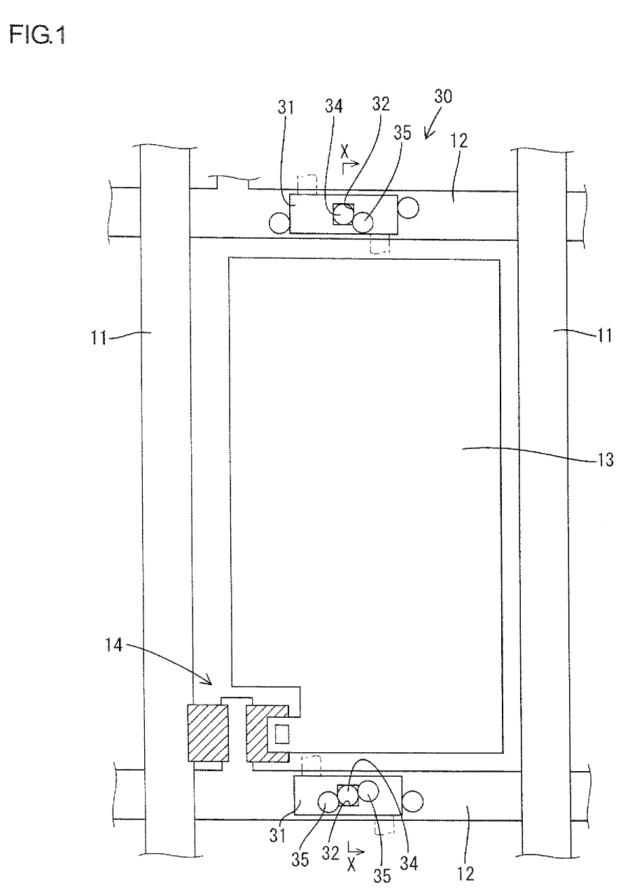

A first example embodiment will be explained with reference to FIGS. 1 through 4. A liquid crystal display device of this embodiment includes a pair of transparent substrates comprising glass, spacer beads 35, and liquid crystal 36. The transparent substrates are a TFT substrate 10 and a CF substrate 20. The TFT substrate 10 and the CF substrate 20 are assembled together in parallel. The spacer beads 35 intervene between the two substrates 10, 20, thereby maintaining a uniform distance (cell gap) between the two substrates 10, 20 over the whole surfaces of the two substrates 10, 20. The liquid crystal 36 is dispensed or sealed in a space between the two substrates 10, 20. The space is thus filled with the liquid crystal.

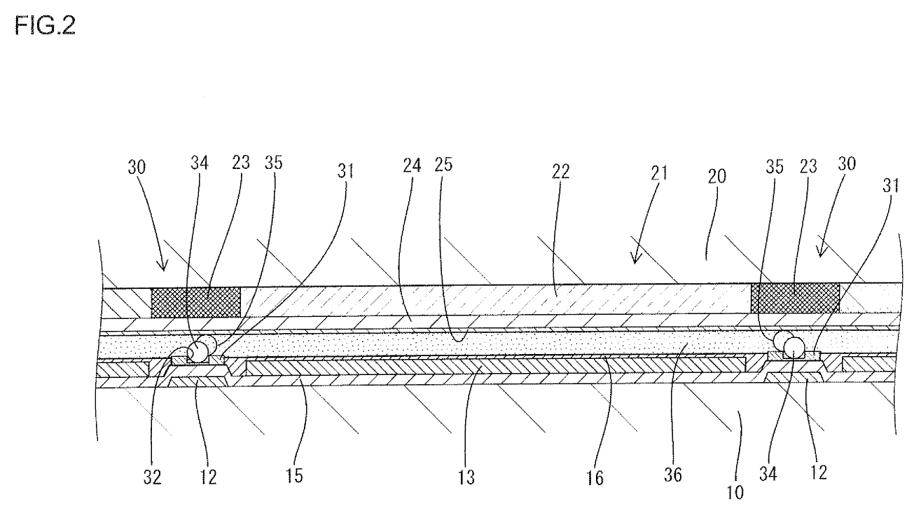

As shown in FIG. 1, a plurality of source lines 11 longitudinally run at equal intervals on an opposed surface to the CF substrate 20 of the TFT substrate 10, and a plurality of gate lines 12 laterally run at equal intervals on the same surface of the TFT substrate 10. The source lines 11 and the gate lines 12 configure a grid-pattern of a plurality of square frames (FIG. 1 shows only one of the frames). A display electrode 13 is disposed in each of the frames. The display electrodes 13 comprise ITO (indium tin oxide) and are transparent. Each of the display electrodes 13 has a generally square thin plate shape. In addition, a driving element 14 is provided in a corner of each of the frames. Each of the driving elements 14 includes a TFT (a thin film transistor). The driving elements 14 are connected to the source lines 11 and the gate lines 12. Note that, as shown in FIG. 2, an insulation layer 15 is formed on the surface (the opposed surface to the CF substrate 20) of the TFT substrate 10 and on the surfaces of the gate lines 12. The display electrodes 13 are formed on a surface of the insulation layer 15. In addition, an alignment layer 16 is formed on a surface of the display electrode 13.

On the other hand, a color filter 21 is provided on a surface of CF substrate 20 that is opposed to the TFT substrate 10. The color filter 21 is constituted by aligning[[,]] and allocating[[,]] a plurality of colored portions 22 in a matrix. The colored portions 22 comprise the three primary colors, i.e. red (R), green (G), and blue (B). A light shield black layer 23 (a black matrix) is formed on the same surface of the CF substrate 20. The light shield black layer 23 is linearly disposed between adjacent ones of the colored portions 22 and around an area where the colored portions 22 are allocated (on an outer perimeter of the CF substrate) so as to prevent light leakage. In addition, a thin plate-shaped common electrode 24 is formed on surfaces of the color filter 21 and the light shield black layer 23 (on the surface opposed to the TFT substrate 10). The common electrode 24 comprises ITO (indium tin oxide) and is transparent. Formed on a surface of the common electrode 24 is an alignment layer 25.

A grid-patterned area on the CF substrate 20 where the light shield black layer 23 is formed corresponds to a grid-patterned area on the TFT substrate 10 where the source lines 11 and the gate lines 12 run. The grid-patterned area defined by the light shield black layer 23 comprises a light shield area 30 that is not involved in image display in the liquid crystal display device. In addition, distribution areas 31 for disposing the spacer beads 35 and positioning concavities 32 are provided in the light shield area 30 on the TFT substrate 10. The distribution areas 31 are provided on the surface of the insulation layer 15 on the gate lines so as to be placed thereon. Each of the distribution area 31 has a generally rectangular shape that is longer in the same direction as a longitudinal direction of the gate lines 12. The each distribution area 31 has a uniform thickness. The distribution areas 31 are simultaneously formed with the display electrode 13 by photolithography process during a process of forming the display electrodes 13. Levels of surfaces of the distribution areas 31 are arranged to be substantially equal to that of a surface of the alignment layer 16.

In addition, positioning concavities 32 are formed in the distribution areas 31. The positioning concavities 32 each are formed by a lengthwise central concave portion and a widthwise central concave portion of the respective distribution area 31. The positioning concavities 32 are formed by an etching process. A planar shape of the each positioning concavity 32 is square. A depth dimension (a level difference dimension between the surface of the distribution area 31 and a bottom surface of the positioning concavity 32) is arranged to be smaller than a diameter of a spacer bead 35 (for example, approximately eighth to fifth of the dimension of the spacer bead 35).

After the distribution areas 31, the positioning concavities 32, and the alignment layer 16 are formed, the spacer beads 35 and a core bead 34 are disposed in each of the distribution areas 31. The spacer beads 35 and the core bead 34 are spherical beads that are undistinguishable from each other before being disposed. The spacer beads 35 and the core bead 34 are comprised of synthetic resin. The surfaces of the spacer beads 35 and the core bead 34 are coated with adhesive (not illustrated). The spacer beads 35 and the core bead 34, being contained in ink (not illustrated), are applied toward the distribution area 31 with an inkjet apparatus (not illustrated). Then, a drop of the ink is applied within an area including the positioning concavity 32.

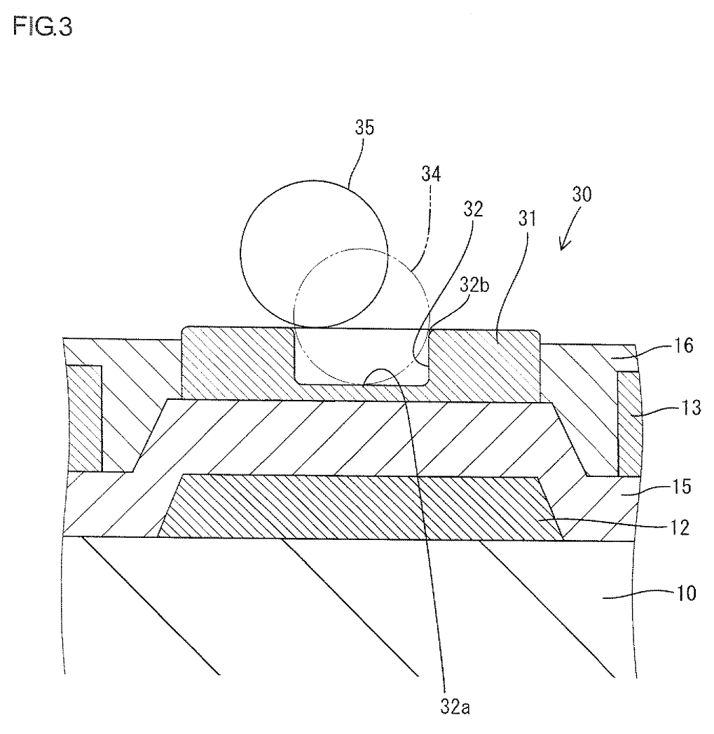

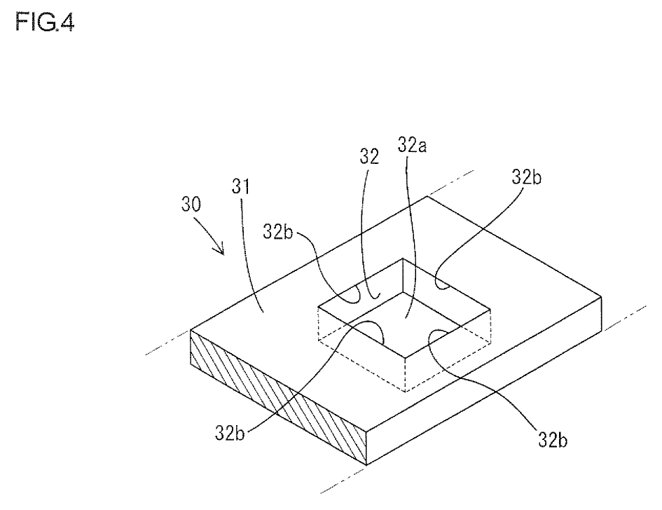

The applied ink gradually vaporizes, maintaining the shape of a single drop by surface tension. The ink drop thus gradually gets smaller in diameter. As the ink drop gets smaller in diameter, a plurality of beads contained in the ink move on the surface of the distribution area 31. While coming closer to each other, one of the beads falls into the positioning concavity 32 (see FIGS. 3 and 4). The bead which is held in the positioning concavity 32 is known as or becomes the core bead 34. The upper portion of the core bead 34 protrudes higher than the surface of the distribution area 31. The core bead 34 abuts on the bottom surface 32a of the positioning concavity 32 while abutting on four sides of an opening edge 32b of the positioning concavity 32. The core bead 34 is thus restricted in movement in directions parallel to the surface of the distribution area 31 (the directions parallel to the TFT substrate 10). After the core bead 34 is held in the positioning concavity 32, as the ink drop gets smaller, the other beads which remain on the surface of the distribution area 31 come closer to the core bead 34, abut on (or come adjacent to) the core bead 34 in due course, and thereby are known as or become the spacer beads 35. When the ink has completely vaporized, the core bead 34 is secured in the positioning concavity 32 by the adhesive on the surface thereof, while the spacer beads 35 are also secured to the surface of the distribution area 31 by the adhesive on the surfaces thereof.

Even if the ink applied toward the distribution area 31 partially runs out of the distribution area 31, one of the beads is held in the positioning concavity 32 and thus becomes the core bead 34 that is restricted in movement. The beads on the outside of the distribution area 31 are then drawn to the core bead 34 in accordance with decrease of the ink drop, and are finally secured within the distribution area 31.

After the spacer beads 35 are disposed as described above, the TFT substrate 10 and the CF substrate 20 are assembled, holding the spacer beads 35 therebetween. The spacer beads 35 then maintain an even space (a cell gap) between the two substrates 10, 20 over the whole area on the two substrates 10, 20. This results in the two substrates 10, 20 being maintained in parallel with higher accuracy. Thereafter, processes such as a dispensing or sealing process of the liquid crystal 36 in the space between the two substrates 10, 20 are performed. Manufacture of the liquid crystal display device is thus performed.

As described above, in accordance with the present embodiment, the spacer beads 35 are drawn to the core beads 34 that are restricted in movement. Therefore, the spacer beads 35 are prevented from being disposed outside the distribution areas 31.

Furthermore, the core bead 34 that is held in the positioning concavity 32 abuts on the opening edges 32b of the positioning concavity 32, and thus the position for holding the core bead 34 in the positioning concavity 32 is settled at a single place. Thus the core bead 34 is fitted in the positioning concavity 32 while being restricted in movement therein. Therefore, positioning accuracy for the spacer beads 35 is high.

### Second Embodiment

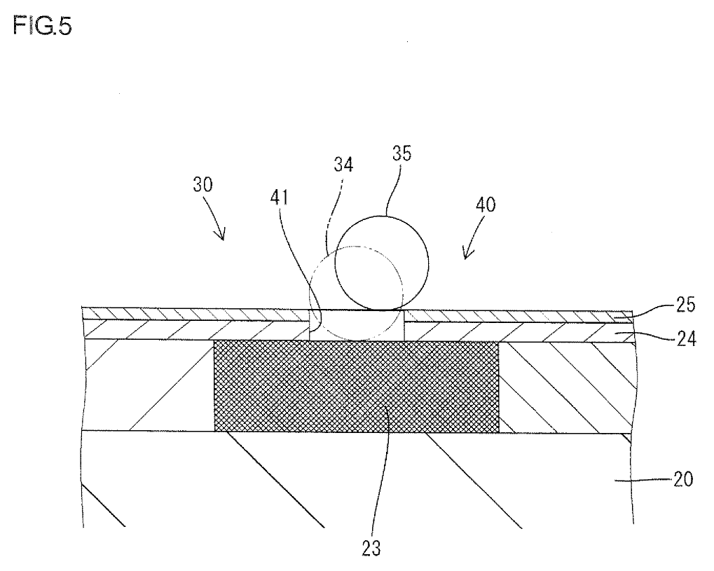

A second example embodiment will be now explained with reference to FIG. 5.

In the present second embodiment, the spacer beads 35 are disposed on the CF substrate 20 instead of on the TFT substrate 10. In FIG. 5, the TFT substrate 10 is arranged to be assembled on the upper side of the CF substrate 20. Distribution areas 40 are ensured within an area that corresponds to the light shield black layer 23 in the light shield area. Positioning concavities 41 for holding the core beads are formed by partially notching of the common electrode 24 and the alignment layer 25 in the distribution areas 30 (portions that corresponds to the light shield black layer 23) by an etching process. Spacer beads 35 are secured to the surface of the alignment layer 25. In the FIG. 5 embodiment, other similar configurations are designated by the same numerals, while repeated explanations are omitted.

### Third Embodiment

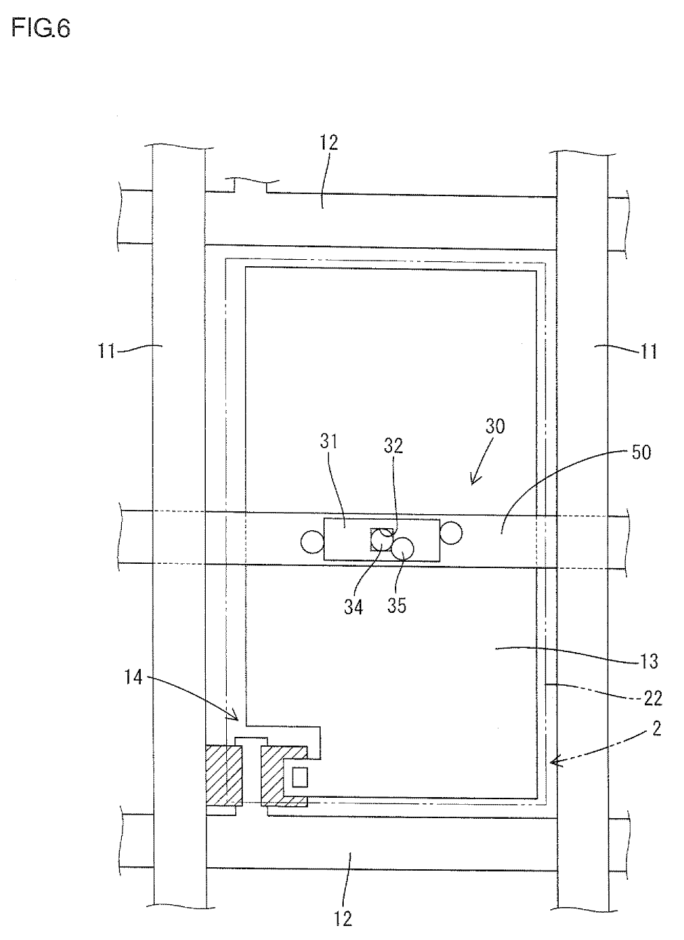

FIG. 6 shows a third example embodiment.

As described above, color filter 21 is configured on the CF substrate 20 by partitioning the plurality of colored portions 22 with a grid-patterned light shield black layer 23 (a black matrix). Supplemental capacitor lines 50 for supplemental capacitors (storage capacitors or additional capacitors) are provided on the TFT substrate 20 in disposition to cross the colored portions 22. Areas that correspond to the supplemental capacitor lines 50 also comprise the light shield area 30. The distribution areas 31 having the positioning concavities 32 that are similar to those of the above first embodiment are formed on the supplemental capacitor lines 50 in the light shield area 30. The core beads 34 are secured to[[,]] and disposed in[[,]] the positioning concavities 32, while the spacer beads 35 are disposed on the surface of the distribution areas 3. Other similar configurations of the third embodiment are similar to those of the first embodiment, and therefore are designated by similar numerals, while repeated explanations are omitted. In addition, in the present embodiment, the supplemental capacitor lines 50 are disposed across the colored portions 22, and the distribution areas 31 and the positioning concavities 32 are disposed in corresponding relation to the colored portions 22. Alternatively, supplemental capacitor lines 50 that do not cross the colored portions 22 may be disposed, and the distribution areas 31 and the positioning concavities 32 may be disposed so as not to correspond to the colored portions 22 (so as to come off out of the colored portions 22).

### Other Embodiments

The present invention is not limited to the embodiments described above with reference to the drawings, the following example embodiments are also included within the scope of the present invention. Further various variations other than the following example embodiments are also possible within the scope and spirit of the invention.

(1) In the above embodiments, the positioning concavities are formed by photolithography and etching processes. However, these processes are not limiting. For example, the positioning concavities may be formed by laser treatment.

(2) In the above embodiments, the distribution areas are disposed on the gate lines, the light shield black layer, or the supplemental capacitor lines. However, not applying only to this, the distribution areas may be disposed on the source lines.

(3) In the above embodiments, the spacer beads are disposed on only one of the TFT substrate and the CF substrate. However, the spacer beads may be disposed on both of the TFT substrate and the CF substrate. In this case, the spacer beads which are disposed on the TFT substrate and the spacer beads which are disposed on the CF substrate shall be disposed so as not to overlap and interfere with each other.

(4) In the above embodiments, the positioning concavities are square, however, the shape is not limited to this. For example, the positioning concavities may be rectangular, circular, elliptical, oval, or the like.

(5) In the above embodiments, the core bead abuts on the opening edge of the positioning concavity, and thus the position where the core bead is held is settled at a single place. However, the core bead may be disposed at any position in a predetermined extent in the positioning concavity.

(6) In the above embodiments, a single core bead is held in each of the positioning concavities. However, a plurality of core beads may be held in each of the positioning concavities.

(7) In the above embodiments, the cases where the driving elements are TFT are explained. However, the present invention may be utilized also in cases where any elements other than TFT, such as MIM (metal insulator metal), comprise the driving elements.

(8) In the above embodiments, a single positioning concavity is provided in each of the distribution areas. However, a plurality of positioning concavities may be formed on the each distribution area.

1.-7. (canceled)

8. A liquid crystal display device, comprising:
two transparent substrates;
a spacer bead configured to hold the two transparent substrates at a desired distance;
liquid crystal that is sealed between the two transparent substrates;
a light shield area that is formed on at least one of the two transparent substrates;
a distribution area formed in the light shield area, the distribution area being an area where the spacer bead is disposed;
a positioning cavity formed in the distribution area, the positioning cavity being concaved relative to a surface of the distribution area;
a core bead that is held in the positioning cavity and restricted in movement relative to the surface of the distribution area; and
a spacer bead that is disposed adjacent to the core bead on the surface of the distribution area.

9. The liquid crystal display device according to claim 8, further comprising a line that is connected to a driving element, wherein the distribution area and the positioning cavity are disposed on the line.

10. The liquid crystal display device according to claim 8, further comprising a light shield black layer that partitions a plurality of pixels, wherein the distribution area and the positioning cavity are disposed on the light shield black layer.

11. The liquid crystal display device according to claim 8, further comprising:
a color filter that is formed on one of the two transparent substrates, the color filter including a plurality of colored portions that is partitioned by a grid-patterned black area; and
a line that is disposed on another one of the two transparent substrates, the line being disposed across the colored portions in a planar view, wherein the distribution area and the positioning cavity are disposed on the line.

12. The liquid crystal display device according to claim 8, further comprising a supplemental capacitor line that is disposed on one of the two transparent substrates, the supplemental capacitor line being for a supplemental capacitor, wherein the distribution area and the positioning cavity are disposed on the supplemental capacitor line.

13. The liquid crystal display device according to claim 8, wherein the core bead that is held in the positioning cavity abuts an opening edge of the positioning cavity, thereby settling a position where the core bead is held in the positioning cavity at a single place.

14. The liquid crystal display device according to claim 9, wherein the core bead that is held in the positioning cavity abuts an opening edge of the positioning cavity, thereby settling a position where the core bead is held in the positioning cavity at a single place.

15. The liquid crystal display device according to claim 10, wherein the core bead that is held in the positioning cavity abuts an opening edge of the positioning cavity, thereby settling a position where the core bead is held in the positioning cavity at a single place.

16. The liquid crystal display device according to claim 11, wherein the core bead that is held in the positioning cavity abuts an opening edge of the positioning cavity, thereby settling a position where the core bead is held in the positioning cavity at a single place.

17. The liquid crystal display device according to claim 12, wherein the core bead that is held in the positioning cavity abuts an opening edge of the positioning cavity, thereby settling a position where the core bead is held in the positioning cavity at a single place.

18. A method of manufacturing a liquid crystal display device, comprising:
forming a positioning cavity in a distribution area that is set in a light shield area on one of a pair of transparent substrates, the positioning cavity being concaved relative to a surface of the distribution area;
applying a plurality of beads with ink to an area including the positioning cavity on the one of the transparent substrates;
as the ink vaporizes, holding one of the plurality of beads in the positioning cavity whereby the one of the plurality of beads becomes a core bead, while drawing the beads which remain on the surface of the distribution area to the core bead as spacer beads;
assembling the pair of transparent substrates with the spacer beads held therebetween and thereby spacing a predetermined distance therebetween; and
dispensing or sealing liquid crystal in a space between the assembled pair of transparent substrates.
